(19) United States
(12) Patent Application Publication
(10) Pub. No.: US 2012/0028161 A1
(43) Pub. Date: Feb. 2, 2012

(54) FUEL CELL

(76) Inventors: Yuuichi Sato, Tokyo (JP); Daisuke Watanabe, Chigasaki-shi (JP); Genta Oomichi, Yokohama-shi (JP); Nobuyasu Negishi, Yokohama-shi (JP); Hirofumi Kan, Kawasaki-shi (JP); Yukinori Akamoto, Yokohama-shi (JP)

(21) Appl. No.: 13/267,147

(22) Filed: Oct. 6, 2011

Related U.S. Application Data
(63) Continuation of application No. PCT/JP2010/055256, filed on Mar. 25, 2010.

(30) Foreign Application Priority Data
Apr. 10, 2009 (JP) 2009-096108

(51) Int. Cl. H01M 8/10

(52) U.S. Cl. 429/479

(57) ABSTRACT

According to one embodiment, a fuel cell includes a membrane electrode assembly including a plurality of anodes, a plurality of cathodes each forming a pair with a corresponding one of the plurality of anodes, and an electrolyte membrane interposed between the anodes and the cathodes, a current collector configured to interpose the membrane electrode assembly in between, a fuel supply mechanism arranged on the side of the anodes of the membrane electrode assembly and configured to supply the anodes with a fuel, and a moisturizing layer arranged on the side of the cathodes of the membrane electrode assembly. The current collector includes a slit arranged so as to face a region between the cathodes.

### CROSS REFERENCE TO RELATED APPLICATIONS

This application is a Continuation Application of PCT Application No. PCT/JP2010/055256, filed Mar. 25, 2010 and based upon and claiming the benefit of priority from prior Japanese Patent Application No. 2009-096108, filed Apr. 10, 2009, the entire contents of all of which are incorporated herein by reference.

### FIELD

Embodiments described herein relate generally to fuel cells and, more particularly, to a fuel cell in which a liquid fuel is used.

### BACKGROUND

Recently, attempts have been made to use fuel cells as a power sources for portable various types of electronic device, such as notebook computers and cellular phones, in order to allow long hours of use without charging. A fuel cell has the advantages of generating electricity merely by being supplied with fuel and air, and continuing generating electricity for long hours merely by replenishing the fuel. Therefore, a fuel cell having a smaller size would be exceptionally advantageous as a power source for portable electronic devices.

A direct methanol fuel cell (DMFC) is a promising candidate as a power source for portable electronic devices, since a DMFC can be formed in a small size and the fuel is easy to handle.

Known methods for supplying a DMFC with a liquid fuel include active types such as a gas supply type and liquid supply type, and passive types such as an internal vaporization type, in which a liquid fuel in a fuel container is vaporized inside the cell and supplied to the fuel electrode.

Various schemes can be adopted in order to supply the anode (fuel electrode) with fuel. For example, there is a scheme to directly distribute a liquid fuel such as a methanol solution to below an anode conductive layer. In an external vaporization type, methanol, for example, is vaporized outside the fuel cell so as to produce a gaseous fuel, and the gaseous fuel is distributed to below an anode conductive layer. In an internal vaporization type, a liquid fuel such as pure methanol and a methanol solution is contained in a fuel container, and the liquid fuel is vaporized inside the cell and supplied to the anode.

Means for supplying the cathode (air electrode) with air as an oxidant include active types in which air is forcibly supplied by a fan or a blower, and spontaneous breathing (passive) types in which air is supplied only by natural distribution of the atmosphere.

Of these types, the passive types such as the internal vaporization type have a special advantage in reducing the size of a DMFC. A passive DMFC has been proposed in which a membrane electrode assembly (fuel cell) including a fuel electrode, an electrolyte membrane, and an air electrode, for example, is arranged on a box-shaped fuel container made of resin. The membrane electrode assembly is interposed between an anode conductive layer provided on the fuel electrode side, and a cathode conductive layer provided on the air electrode side.

A liquid fuel supplied to a fuel supply through a duct from the fuel container is supplied to an anode gas diffusion layer of the fuel cell via a fuel distribution layer and the anode conductive layer in the original form of the liquid fuel, or in a state in which the liquid fuel and an evaporated fuel into which the liquid fuel has evaporated are mixed. The fuel supplied to the anode gas diffusion layer is diffused in the anode gas diffusion layer and supplied to the anode catalyst layer. When methanol fuel is used as the liquid fuel, an internal reforming reaction of methanol occurs in the anode catalyst layer, as represented by formula (1), as follows:

CH₃OH+H₂O→CO₂+6H⁺+6e⁻ Formula (1)

When pure methanol is used as the methanol fuel, the methanol is reformed by the internal reforming reaction represented by (1) with water produced in the cathode catalyst layer or water in the electrolyte membrane, or is reformed by another reaction mechanism that does not require water.

The electrons (e⁻) produced in this reaction are drawn to the outside via the conductive layer, operate a portable electronic device, for example, as electricity, and are then drawn to the cathode. Integrally forming the conductive layer on a fix layer formed of an insulating film, for example, has also been considered.

Further, the protons (H⁺) produced in the internal reforming reaction represented by formula (1) are drawn to the cathode through the electrolyte membrane. Air is supplied to the cathode as an oxidant gas via a moisturizing layer. The electrons (e⁻) and protons (H⁺) that have reached the cathode react with atmospheric oxygen in the cathode catalyst layer, which electricity generating reaction yields water, as represented in formula (2), as follows:

(3/2)O₂+6e⁻+6H⁺→3H₂O Formula (2)

In order to cause the internal reforming reaction to occur smoothly and obtain a high, stable output in the fuel cell, at least a portion of the water (H₂O) produced in the cathode catalyst layer as represented in formula (2) needs to smoothly undergo the cycle of penetrating the electrolyte membrane, diffusing across the anode catalyst layer, and being consumed in the reaction represented in formula (1).

In order to achieve this, a moisturizing layer, which impregnates the water produced in the cathode catalyst layer so as to prevent vaporization, is provided in the vicinity of the cathode, such that the amount of water retained in the cathode catalyst layer becomes greater than the amount of water retained in the anode catalyst layer, and the water produced in the cathode catalyst layer is supplied to the anode catalyst layer via the electrolyte membrane using the osmotic pressure effect.

In the above-described fuel cell in which supply of water from the cathode to the anode is facilitated using a moisturizing layer, a large amount of water is constantly retained in the cathode catalyst layer while the fuel cell generates electricity. Continuation of electricity generation in this state over a long time may cause flooding, in which pores of the cathode catalyst layer are blocked by water, and the diffusibility of air in the cathode catalyst layer decreases, thereby decreasing electricity generating properties.

The frequent occurrence of flooding is closely associated with the temperature of the cathode of the fuel cell that is generating electricity. When the temperature of the cathode is high, since the steam pressure of water in the cathode catalyst layer is high, the steam easily permeates the moisturizing layer and evaporates into the open air. When the temperature of the cathode is low, on the other hand, since the steam pressure of water is low in the cathode catalyst layer and in the periphery thereof, the steam does not greatly evaporate into the open air, causing flooding to occur easily.

In a conventional fuel cell, however, the temperature of the cathode is not necessarily uniform at all areas, and temperature distribution usually occurs in a plane direction (X-Y direction shown in FIG. 1) of the membrane electrode assembly. In particular, in the portion at the border between the cathode catalyst layer and the neighboring space thereof, the steam easily condenses due to a sudden change in temperature. Therefore, flooding easily occurs in the peripheral portion of the cathode catalyst layer, in particular.

When air is not supplied smoothly to the cathode, the above-described reaction at the cathode does not occur smoothly, thereby decreasing electricity generating properties.

### BRIEF DESCRIPTION OF THE DRAWINGS

FIG. 1 is a cross-sectional view illustrating a configuration example of a fuel cell according to First example;

FIG. 2 illustrates a configuration example of a current collector of the fuel cell according to First example;

FIG. 3 illustrates a configuration example of a current collector of a fuel cell according to Second example;

FIG. 4 illustrates an example of the result of measuring output voltages of the fuel cells, according to First example, Second example, and First comparative example;

FIG. 5 is a cross-sectional view illustrating a configuration example of a fuel cell according to Third example;

FIG. 6 illustrates a configuration example of a current collector of the fuel cell according to Third example;

FIG. 7 illustrates a configuration example of a current collector of a fuel cell according to Fourth example;

FIG. 8 illustrates a configuration example of a current collector of a fuel cell according to Sixth example; and

FIG. 9 illustrates an example of the result of measuring output voltages of the fuel cells according to Third to Sixth examples and Second comparative example.

### DETAILED DESCRIPTION

In general, according to one embodiment, a fuel cell comprises a membrane electrode assembly including a plurality of anodes, a plurality of cathodes each forming a pair with a corresponding one of said plurality of anodes, an electrolyte membrane interposed between the anodes and the cathodes; a current collector configured to interpose the membrane electrode assembly in between; a fuel supply mechanism arranged on the side of the anodes of the membrane electrode assembly and configured to supply the anodes with a fuel; and a moisturizing layer arranged on the side of the cathodes of the membrane electrode assembly. The current collector includes a slit arranged so as to face a region between the cathodes.

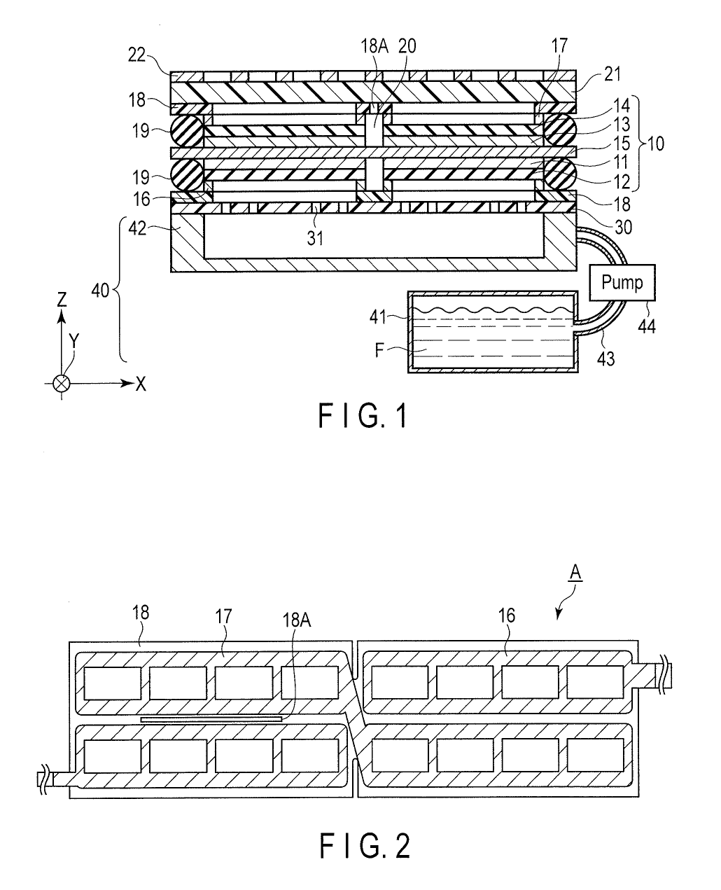

Hereinafter, a fuel cell according to an embodiment will be described with reference to the accompanying drawings. A fuel cell according to an embodiment comprises a membrane electrode assembly 10, including a plurality of anodes (fuel electrodes), a plurality of cathodes (air electrodes), and an electrolyte membrane 15 interposed between the anodes and the cathodes, as shown in FIG. 1, for example.

Each of the anodes includes an anode gas diffusion layer 12, and an anode catalyst layer 11 arranged on the anode gas diffusion layer 12. Each of the cathodes includes a cathode gas diffusion layer 14 and a cathode catalyst layer 13 arranged on the cathode gas diffusion layer 14.

The membrane electrode assembly 10 is interposed by the current collector A. The current collector A includes a cathode conductive layer 17 contacting the cathode gas diffusion layer 14, an anode conductive layer 16 contacting the anode gas diffusion layer 12, and a fixing layer 18 configured to fix the cathode conductive layer 17 and the anode conductive layer 16.

A fuel supply mechanism 40 designed to supply the anodes with a fuel is arranged on the anode side of the membrane electrode assembly 10. A moisturizing layer 21 configured to retain water produced at the cathodes so as to suppress vaporization is arranged on the cathode side of the membrane electrode assembly 10.

According to the fuel cell of the present embodiment, a slit 18A is provided in the fixing layer 18 so as to face a region between the cathode gas diffusion layer 14 and the cathode catalyst layer 13 (which will be collectively referred to as “cathode”), which are arranged side by side. Hereinafter, examples of the fuel cell according to the present embodiment will be described.

### FIRST EXAMPLE

Hereinafter, a fuel cell according to First example will be described. A perfluorocarbon sulfonic acid solution as a proton-conductive resin, and water and methoxypropanol as a disperse medium are added to carbon black that supports anode catalyst particles (Pt:Ru=1:1), and the carbon black that supports the anode catalyst particles is dispersed so as to prepare paste.

The paste thus obtained is applied to a porous carbon paper as the anode gas diffusion layer 12, thereby obtaining the anode catalyst layer 11 having an approximately rectangular shape.

A perfluorocarbon sulfonic acid solution as a proton-conductive resin, and water and methoxypropanol as a disperse medium are added to carbon black that supports cathode catalyst particles (Pt), and the carbon black that supports the cathode catalyst particles is dispersed so as to prepare paste. The obtained paste is applied to a porous carbon paper as the cathode gas diffusion layer 14, thereby obtaining the cathode catalyst layer 13 having an approximately rectangular shape. In a direction approximately parallel to the X-Y plane, the anode gas diffusion layer 12 and the cathode gas diffusion layer 14 have the same size and shape, and the anode catalyst layer 11 and the cathode catalyst layer 13 applied on the gas diffusion layers 12, 14 have the same size and shape as well.

A perfluorocarbon sulfonic acid membrane (trade name Nafion® by DuPont) as the electrolyte membrane 15 is arranged between the anode catalyst layer 11 and the cathode catalyst layer 13 prepared as described above, and the anode catalyst layer 11 and the cathode catalyst layer 13 are aligned so as to face each other and hot-pressed, and thereby the membrane electrode assembly 10 is obtained.

According to the fuel cell of the present example, as shown in FIGS. 1 and 2, the membrane electrode assembly 10 is formed by forming each of the anode gas diffusion layer 12 and the cathode gas diffusion layer 14 in an approximately rectangular outer shape, and hot-pressing the two pairs of anode gas diffusion layers 12 and the two cathode gas diffusion layers 14 so as to be arranged side by side at intervals of 1.5 mm, approximately parallel to one another in the longitudinal direction (Y-direction).

After that, the membrane electrode assembly 10 is interposed by the current collector A. The current collector A is formed by integrating the anode conductive layer 16 and the cathode conductive layer 17 including a plurality of openings with the fixing layer 18 including openings with the same shape. Each of the anode conductive layer 16 and the cathode conductive layer 17 can be formed of, for example, a porous layer (such as a mesh) formed of metal materials such as gold and nickel, or a composite obtained by coating a conductive metal material such as a foil, a thin film, or stainless steel (SUS) with a high-conductive metal such as gold. The fixing layer 18 can be formed of an insulating film formed of polyethylene terephthalate (PET) in the same outer shape as that of the electrode.

The cathode conductive layer 17, the anode conductive layer 16, and the fixing layer 18 are formed in the shapes shown in FIG. 2 by folding the current collector A in two interposing the membrane electrode assembly 10 in between, such that the above-described two pairs of anode catalyst layers 11 and the cathode catalyst layers 13 are electrically connected in series. As shown in FIG. 1, the cathode conductive layer 17 is integrated with the fixing layer 18 in a position in which the cathode conductive layer 17 contacts the cathode. The anode conductive layer 16 is integrated with the fixing layer 18 in a position in which the anode conductive layer 16 contacts the anode.

As shown in FIG. 1 and FIG. 2, one slit 18A is formed in the fixing layer 18. The slit 18A is arranged in a portion of the fixing layer 18 facing a region between the two cathodes, so as to extend approximately parallel to the longitudinal direction

(Y-direction) of the cathodes. The width of the slit 18A in a direction (X-direction) approximately orthogonal to the longitudinal direction of the slit 18A is approximately 0.3 mm. The slit is provided so as to have a length half the length of the electrode in the longitudinal direction, and is arranged such that the central portion of the electrode in the longitudinal direction is aligned with the central portion of the slit in the longitudinal direction.

A rubber O-ring 19 is interposed between the electrolyte membrane 15 and the fixing layer 18 and is sealed, so as to have a width of 2 mm in the cross section shown in FIG. 1 and an approximately rectangular outer shape, which is the same as that of the fixing layer 18. Further, a gas discharge vent 20 is provided in a portion of the electrolyte membrane 15 facing a region between the anode gas diffusion layers 12 arranged approximately parallel to each other.

On the cathode conductive layer 17, there are provided a moisturizing layer 21, and a surface cover 22 including a plurality of air inlets 23 laminated on the moisturizing layer 21.

The moisturizing layer 21 is positioned on the other side of the electrolyte membrane 15 with respect to the cathode gas diffusion layer 14. The moisturizing layer 21 has the functions of suppressing vaporization of water by impregnating a portion of water produced in the cathode catalyst layer 13, and facilitating uniform diffusion of the oxidant (air) into the cathode catalyst layer 13 by uniformly introducing the oxidant into the cathode gas diffusion layer 14. The moisturizing layer 21 is formed of a porous member, for example, and specific constituent materials include porous bodies of polyethylene and polypropylene. In the present example, the moisturizing plate 9 is a foamed polyethylene sheet.

The surface cover 22 is positioned on the other side of the cathode conductive layer 17 with respect to the moisturizing layer 21. The surface cover 22 has an approximately box-shaped outer appearance, and is formed of stainless steel (SUS), for example. Further, the surface cover 22 includes a plurality of air inlets 23 designed to take in air as an oxidant. The air inlets 23 are formed in a matrix pattern, for example.

In each of the moisturizing layer 21 and the surface cover 22, a hole is provided in a position corresponding to the gas discharge vent 20, so as not to obstruct the gas discharged from the gas discharge vent 20.

The fuel supply mechanism 40, which supplies liquid fuel F to the fuel distribution layer 30, mainly comprises a fuel container 41, a fuel supply 42, and a duct 43, as shown in FIG. 1. The fuel container 41 contains the liquid fuel F compliant with the fuel cell. Examples of the liquid fuel F include methanol fuels, such as methanol solutions of various concentrations, and pure methanol. The liquid fuel F is not necessarily limited to methanol fuels.

The liquid fuel F may be, for example, an ethanol fuel such as an ethanol solution and pure ethanol, a propanol fuel such as a propanol solution and pure propanol, a glycol fuel such as a glycol solution and pure glycol, dimethyl ether, formic acid, or other liquid fuels. In either case, a liquid fuel compliant with the fuel cell is contained in the fuel container 41.

The fuel supply 42 is connected to the fuel container 41 through the duct 43 of the liquid fuel F formed of plumbing, for example. The liquid fuel F is introduced into the fuel supply 42 through the duct 43 from the fuel container 41, and the introduced liquid fuel F and/or vaporized components of the liquid fuel F are supplied to the membrane electrode assembly 10 through the fuel distribution layer 30 and the anode conductive layer 16.

The duct 43 is not limited to plumbing independent of the fuel supply 42 and the fuel container 41. When the fuel supply 42 and the fuel container 41 are laminated and integrated, for example, the duct 43 may be formed as a duct of the liquid fuel F connecting the fuel supply 42 and the fuel container 41. That is, the fuel supply 42 only needs to communicate with the fuel container 41 via a duct or the like.

The liquid fuel F contained in the fuel container 41 can be dropped and transported to the fuel supply 42 via the duct 43 by means of gravity. Further, the duct 43 may be filled with a porous body, for example, such that the liquid fuel F contained in the fuel container 41 is transported to the fuel supply 42 by a capillary phenomenon. Moreover, as shown in FIG. 1, a pump 44 may be intervened in a portion of the duct 43, such that the liquid fuel F contained in the fuel container 41 is forcibly transported to the fuel supply 42.

The fuel distribution layer 30 is formed of a flat plate in which a plurality of openings 31 are formed, for example, and is interposed between the anode gas diffusion layer 12 and the fuel supply 42. The fuel distribution layer 30 is formed of a material that does allow the liquid fuel F and the vaporized components of the liquid fuel F to permeate. More specifically, the fuel distribution layer 30 is formed of a polyethylene terephthalate (PET) resin, a polyethylene naphthalate (PEN) resin, a polyimide-based resin, or the like.

Further, the fuel distribution layer 30 may be formed of a vapor-liquid separation film configured to separate vaporized components of the liquid fuel F from the liquid fuel F and let the vaporized components to permeate the side of the membrane electrode assembly 10, for example. The vapor-liquid separation film can be formed of silicone rubber, a low-density polyethylene (LDPE) film, a polyvinyl chloride (PVC) film, a polyethylene terephthalate (PET) film, or a fluorine resin (such as polytetrafluoroethylene (PTFE) and a tetrafluoroethylene-perfluoroalkyl vinyl ether copolymer (PFA)) microporous film, for example.

In an environment where the temperature was 25° C. and the relative humidity is 50%, pure methanol having a purity of 99.9% by weight was supplied to the fuel cell prepared as described above. Under the above-described conditions, the output voltage of the fuel cell after generating electricity for 100 hours (or at the time of start of electricity generation) was measured.

### SECOND EXAMPLE

Hereinafter, a fuel cell according to Second example will be described. In the description that follows, the same structural elements as those of the fuel cell of First example will be denoted by the same reference numbers and detailed descriptions of such elements will be omitted.

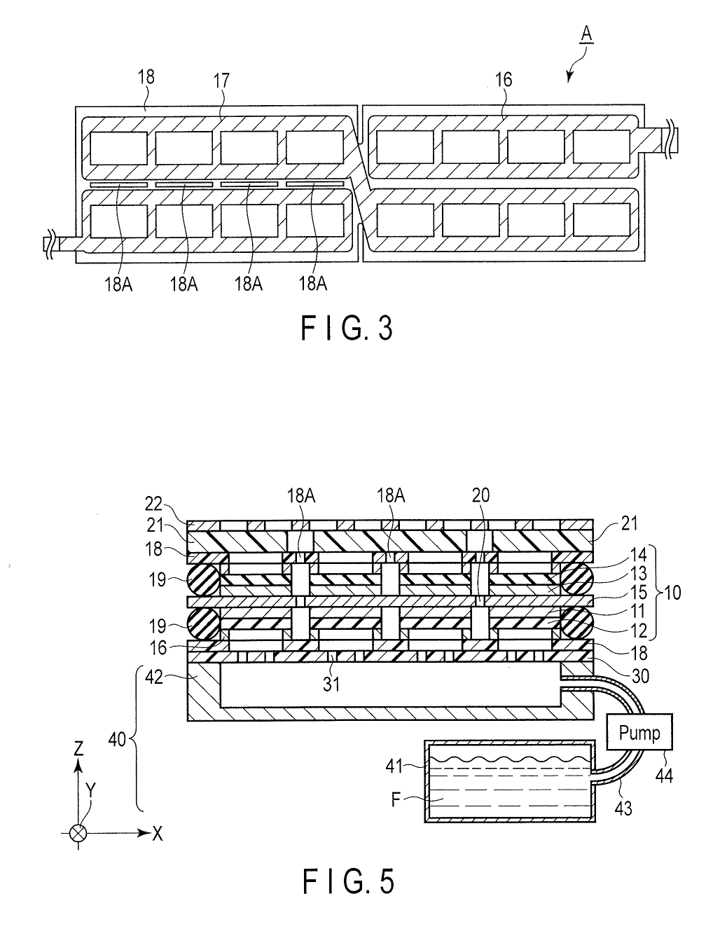

In the fuel cell of the present example, four slits 18A are provided in portions facing regions between cathodes of a current collector A, as shown in FIG. 3. The four slits 18A are arranged side by side in the Y-direction such that the longitudinal direction thereof is approximately parallel to the longitudinal direction (Y-direction) of the cathodes. The width of the slits 18A in a direction (X-direction) approximately orthogonal to the longitudinal direction of the slits 18A is approximately 0.3 mm. The slits are provided so as to have a length of ⅕ of the length of the electrode in the longitudinal direction, and are arranged at equal intervals at diametrically opposed positions with respect to the central portion of the electrode in the longitudinal direction.

Other than the configuration of the slits 18A, the fuel cell of the present example has the same configuration as that of the above-described fuel cell of First example. In the same manner as in First example, the output voltage of the fuel cell of the present example was measured.

### First Comparative Example

Hereinafter, a fuel cell according to First comparative example will be described. The fuel cell of the present comparative example is the same the fuel cell of First example, except that a slit is not formed in a portion of a current collector A facing a region between cathodes. In the same manner as in First example, the output voltage of the fuel cell of First comparative example was measured.

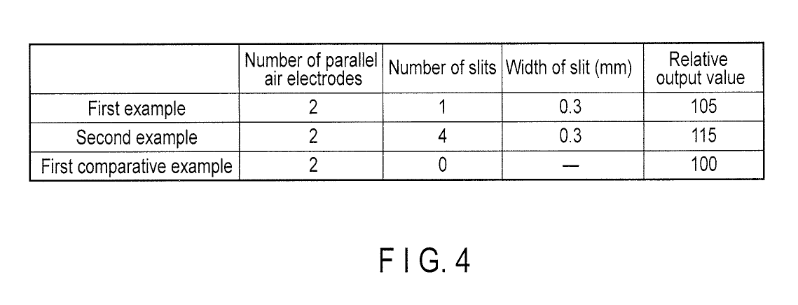

As shown in FIG. 4, assuming the measured output voltage of the fuel cell according to First comparative example to be 100, the output voltage of the fuel cell according to First example was 105, and the measured output voltage of the fuel cell according to Second example was 115.

That is, the fuel cells of First example and Second example exhibited output voltages higher than that of the fuel cell of First comparative example, since the slits 18A provided in a portion of the current collector A facing the region between the cathodes allowed the steam produced at the cathode to escape and air to be taken in from the outside, causing the reaction at the cathode to occur smoothly.

That is, according to the above-described fuel cells of First example and Second example, it is possible to provide a fuel cell capable of maintaining a stable output over a long time.

### THIRD EXAMPLE

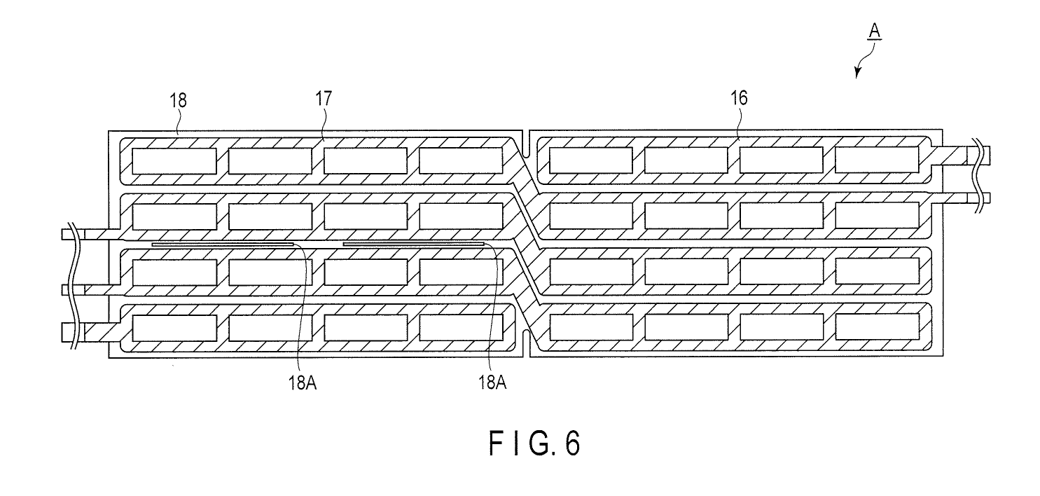

A fuel cell according to Third example will be described below. In the fuel cell of the present example, as shown in FIGS. 5 and 6, a membrane electrode assembly 10 is formed by forming an anode gas diffusion layer 12 and a cathode gas diffusion layer 14 in an approximately rectangular outer shape, and hot-pressing four pairs of anode gas diffusion layers 12 and four cathode gas diffusion layers 14 such that the anode gas diffusion layers 12 and the cathode gas diffusion layers 14 are arranged side by side at intervals of 1.5 mm approximately parallel to one another in the longitudinal direction (Y-direction).

An O-ring 19 is formed in an approximately rectangular outer shape, which is the same as that of the electrode, so as to have a width of 2 mm in the cross section shown in FIG. 5. A gas discharge vent 20 is provided in four portions of an electrolyte membrane 15 between anode gas diffusion layers arranged approximately parallel to one another.

A cathode conductive layer 17, an anode conductive layer 16 and a fixing layer 18 are formed in the shapes shown in FIG. 6, such that the four pairs of anode catalyst layers 11 and the cathode catalyst layers 13 are electrically connected in series. Further, in the fuel cell of the present example, two slits 18A are provided in a fixing layer 18. The slits are provided so as to have a length of ⅓ of the length of the electrode in the longitudinal direction, and are arranged at equal intervals at diametrically opposed positions with respect to the central portion of the electrode in the longitudinal direction.

The two slits 18A are arranged side by side in the

Y-direction in portions of the current collector A facing regions between the cathodes, such that the longitudinal direction of the slits 18A is approximately parallel to the longitudinal direction (Y-direction) of the cathodes. In the present example, two slits 18A are provided in the central part of portions of the current collector A facing regions between the three cathodes arranged side by side in the X-direction. The width of the slits 18A in a direction (X-direction) approximately orthogonal to the longitudinal direction of the slits 18A is approximately 0.3 mm.

Other than the above-described configuration, the fuel cell of the present example has the same configuration as that of the fuel cell of First example. In the same manner as in First example, the output voltage of the fuel cell according to Third example was measured.

### FOURTH EXAMPLE

Hereinafter, a fuel cell according to fourth example will be described. In the description that follows, the same configuration as that of the fuel cell of Third example will be denoted by the same reference numbers and detailed descriptions of such elements will be omitted.

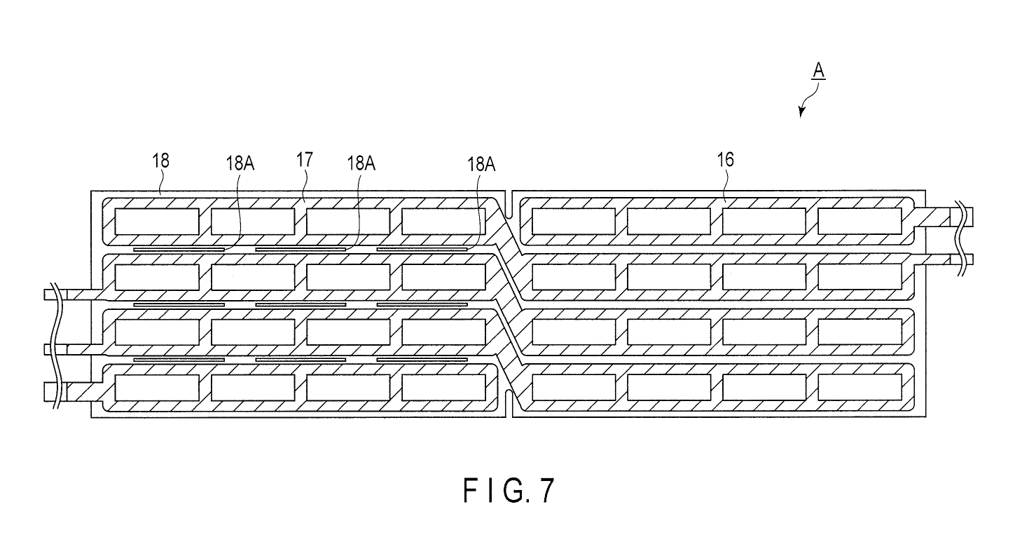

In the fuel cell of the present example, nine slits 18A are provided in portions of the current collector A facing regions between the cathodes. As shown in FIG. 7, three slits 18A are provided in portions facing regions between three cathodes arranged side by side in the X-direction. The three slits 18A are arranged side by side in the Y-direction such that the longitudinal direction of the slits 18A is approximately parallel to the longitudinal direction (Y-direction) of the cathodes. The width of the slits 18A in a direction (X-direction) approximately orthogonal to the longitudinal direction of the slits 18A is 0.3 mm.

Other than the configuration described above, the fuel cell of the present example has the same configuration as that of the fuel cell of Third example. In the same manner as in First example, the output voltage of the fuel cell of fourth example was measured.

### FIFTH EXAMPLE

Hereinafter, a fuel cell according to Fifth example will be described. In the fuel cell of the present example, nine slits 18A are provided in portions of a current collector A facing regions between the cathodes. In the same manner as in fourth example, three slits 18A are provided in portions facing regions between three cathodes arranged side by side in the X-direction. The three slits 18A are arranged side by side in the Y-direction such that the longitudinal direction of the slits 18A is approximately parallel to the longitudinal direction (Y-direction) of the cathodes. In the present example, the width of the slits 18A in a direction (X-direction) approximately orthogonal to the longitudinal direction of the slits 18A is 0.05 mm.

Other than the configuration described above, the fuel cell of the present example has the same configuration as that of the fuel cell of Third example. In the same manner as in First example, the output voltage of the fuel cell of Fifth example was measured.

### SIXTH EXAMPLE

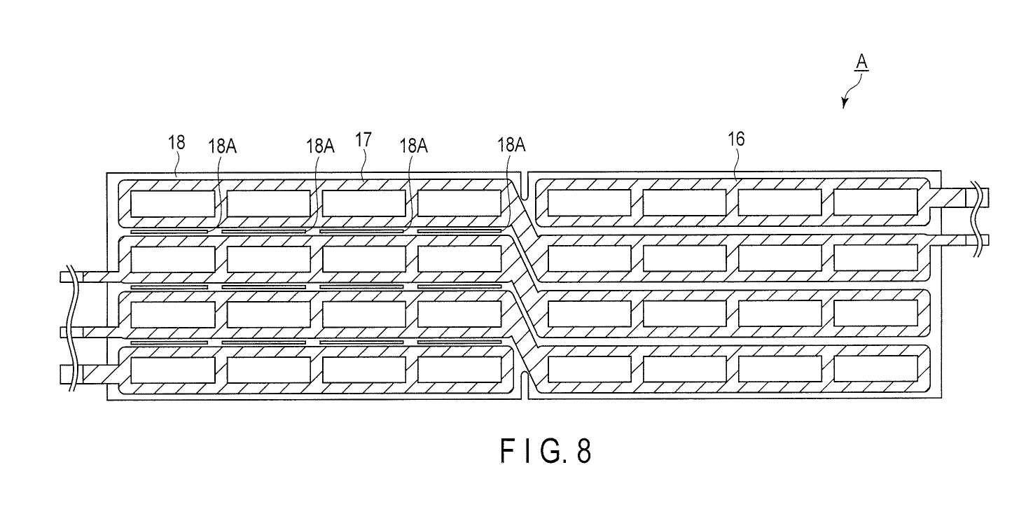

Hereinafter, a fuel cell according to Sixth example will be described. In the fuel cell of the present example, twelve slits 18A are provided in portions of a current collector A facing regions between the cathodes. As shown in FIG. 8, four slits 18A are provided in portions facing regions between three cathodes arranged side by side in the X-direction. The four slits 18A are arranged side by side in the Y-direction such that the longitudinal direction of the slits 18A is approximately parallel to the longitudinal direction (Y-direction) of the cathodes. In the present example, the width of the slits 18A in a direction (X-direction) approximately orthogonal to the longitudinal direction of the slits 18A is 0.3 mm.

Other than the configuration described above, the fuel cell of the present example has the same configuration as that of the fuel cell of Third example. In the same manner as in First example, the output voltage of the fuel cell of Sixth example was measured.

### Second Comparative Example

Hereinafter, a fuel cell according to Second comparative example will be described. In the fuel cell of the present comparative example, a slit is not formed in a portion of the current collector A facing regions between the cathodes. Other than that, the fuel cell of Second comparative example has the same configuration as that of Third example. In the same manner as in First example, the output voltage of the fuel cell of Second comparative example was measured.

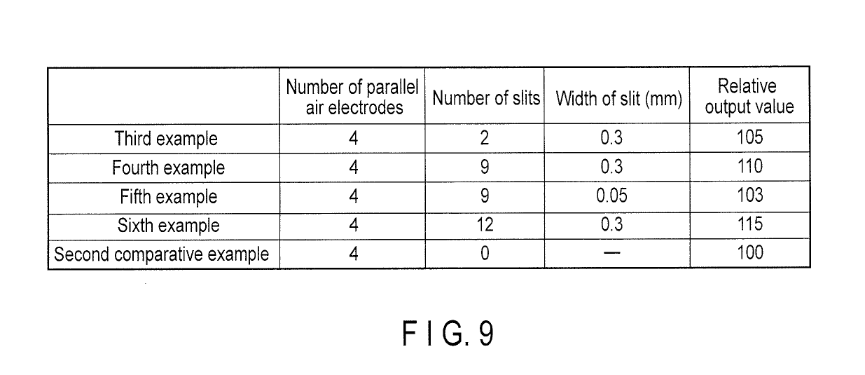

As shown in FIG. 9, assuming the measured output voltage of the fuel cell according to Second comparative example to be 100, the output voltage of the fuel cell according to Third example was 105, the measured output voltage of the fuel cell according to fourth example was 110, the measured output voltage of the fuel cell according to Fifth example was 103, and the measured output voltage of the fuel cell according to Sixth example was 115.

That is, the fuel cells according to Third to

Sixth examples exhibited output voltages higher than that of the fuel cell according to Second comparative example, since the slits 18A provided in portions of the current collector A facing the regions between the cathodes allowed the steam produced at the cathode to escape and air to be taken in from the outside, causing the reaction at the cathode to occur smoothly.

That is, according to the above-described fuel cells of Third to Sixth examples, it is possible to provide a fuel cell capable of maintaining a stable output over a long time.

According to the present embodiment, it is possible to provide a fuel cell capable of maintaining a stable output for a long time.

The present invention is not limited to the above-described embodiment and may be embodied with modifications to the constituent elements within the scope of the invention. For example, in the fuel cell of the above-described embodiments, the current collector A includes a fixing layer configured to fix the cathode conductive layer and the anode conductive layer and a slit is provided in the fixing layer, but a slit may be provided in the conductive layer if the current collector A does not comprise a fixing layer. Even with that configuration, the same advantageous effect as that of the fuel cell of the above-described embodiment can be obtained.

Further, various inventions may be made by appropriately combining constituent elements disclosed in the above-described embodiment. For example, some of the constituent elements may be deleted from all the constituent elements disclosed in the embodiment. Moreover, constituent elements disclosed in different embodiments may be combined as appropriate.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A fuel cell, comprising:
a membrane electrode assembly including a plurality of anodes, a plurality of cathodes each forming a pair with a corresponding one of said plurality of anodes, and an electrolyte membrane interposed between the anodes and the cathodes;
a current collector configured to interpose the membrane electrode assembly in between;
a fuel supply mechanism arranged on the side of the anodes of the membrane electrode assembly and configured to supply the anodes with a fuel; and
a moisturizing layer arranged on the side of the cathodes of the membrane electrode assembly,
wherein the current collector includes a slit arranged so as to face a region between the cathodes.

2. The fuel cell of claim 1, wherein the current collector includes a cathode conductive layer contacting the cathode, and a fixing layer configured to fix the cathode conductive layer, and the slit is provided in the fixing layer.

3. The fuel cell of claim 1, wherein the electrolyte membrane includes a gas outlet, and the gas outlet is arranged so as to face the slit.

4. The fuel cell of claim 2, wherein the electrolyte membrane includes a gas outlet, and the gas outlet is arranged so as to face the slit.
